(19) United States
(12) Patent Application Publication
(10) Pub. No.: US 2013/0292936 A1
(43) Pub. Date: Nov. 7, 2013

(54) Pipe Arrangement and Process

(71) Applicant: Hermann Rosen, Kastanienbaum (Horw LO) (CH)

(72) Inventor: Hermann Rosen, Kastanienbaum (Horw LO) (CH)

(73) Assignee: ROSEN SWISS AG, Stans (CH)

(21) Appl. No.: 13/989,461

(22) PCT Filed: Sep. 28, 2011
(86) PCT No.: PCT/EP11/04837

§ 371 Date: Jul. 25, 2013

(30) Foreign Application Priority Data
Nov. 24, 2010 (DE) 10 2010 052 212.0

(51) Int. Cl. F16L 13/02

(52) U.S. Cl. CPC F16L 13/02
USPC 285/53; 228/101

(57) ABSTRACT

Pipe arrangement comprising two pipes and a sleeve (5), wherein both pipes have an outer metal wall (2), an inner, thermosensitive lining (1) of plastic and also end faces (3) facing towards one another and are connected to one another via the sleeve (5), which is arranged outside the pipes and is welded to at least one pipe, wherein an insulator (7) is integrated along a weld seam (6), which is spaced apart from the end face (3) of a first pipe in the longitudinal direction of the pipe and connects the sleeve (5) to said pipe, in the circumferential direction of the pipe and between the metal wall (2) and the lining (1), and process for producing a pipe arrangement, which is distinguished by the fact that the insulator (7) is applied to the inner side of the metal wall (2) of at least one pipe spaced apart from the end face (3) thereof, the latter is then integrated into the metal wall by introducing the lining (1) of the pipe, then this pipe is pushed into a sleeve (5) which is attached to a further pipe provided with a lining, and the sleeve (5) is welded to the metal wall (2) of the pipe along the insulator (7) and on the outside of the pipe.

The present invention relates to a pipe arrangement comprising two pipes and a sleeve, wherein both pipes have an outer metal wall and an inner, heat-sensitive lining of plastic and also end sides facing one another and are connected to one another via the sleeve which is arranged outside the pipes and which is welded to at least one pipe.

A generic prior art is disclosed, for example, in DE 21 58 692 which proposes various arrangements for connecting two pipes provided with a heat-sensitive lining. However, a disadvantage in the solutions shown there, is the considerably larger structure or diameter of the sleeve by comparison to the actual pipe outside diameter. This results in particular through the arrangement of the sleeve at a spacing from the outer side of the pipe in the region of the weld seam.

DE 24 16 308 likewise proposes various solutions for connecting corresponding pipes provided with a heat-sensitive lining. A sleeve is completely dispensed with in that publication and the inner lining is separated from the metal wall in the region of the end sides of the pipes prior to welding the latter. In particular in the construction of pipelines for highly abrasive transport materials such as oil sands, this process is not reliable enough. The separation of the lining by personnel who are often not specially trained during installation of the pipes in situ can lead to critical damage to the lining of the pipes. The welding in the region of the critical abutting edges can increase any damage which is present owing to the unfavourable effect of heat on the heat-sensitive material of the lining. This is undesired by the pipeline operators.

It is therefore the object of the present invention to make more reliable, in a pipe arrangement, the connection of two pipes which are each provided with a heat-sensitive lining.

The object is achieved by a subject matter according to claim 1 and by a process according to claim 12. Further advantages and details of the invention can be taken from the dependent claims which depend from these claims and from the description which follows.

According to the invention, it is provided that an insulator is integrated in the circumferential direction of the pipe and between the metal wall and the lining along a weld seam which is spaced from the end side of a first pipe in the piping longitudinal direction and which connects the sleeve to this pipe. Therefore, during the mounting of the two pipes in situ, only the pipe to be welded to the sleeve has to be introduced therein prior to applying the weld seam. Any damage to the inner lining of the pipe can be excluded. The lining of the pipe does not have to be separated from the metal wall. The connection of the two pipes thus takes place in a manner which is less susceptible to faults. At the same time, it is possible to dispense with the need to enlarge the diameter of the sleeve owing to the spacing to be provided between sleeve and outer side/wall of the metal wall of the pipe, since the insulator is integrated in the pipe. By integration in this case is meant the introduction of the insulator between lining and pipe wall. The insulator is preferably separated from the pipe interior and is bounded on all sides by the lining, an intermediate layer or adhesive layer or the inner surface of the metal wall.

By virtue of the spacing of the weld seam from the end side of the pipe, with in particular the insulator also being spaced from the end side, an unfavourable effect of the welding process on the region of the end edges is avoided. In the particularly critical region of the mutually facing end sides of the pipe, the lining can then bear directly against the metal wall or against a possible adhesive layer or intermediate layer. The weld seam is preferably situated at least 5 cm away from the abutting edge.

A pipe arrangement according to the invention is particularly advantageous if the insulator is already fastened to the metal wall of the pipe during or before the introduction of the lining of this pipe.

Here, the insulator can be fastened either directly on the metal wall of the pipe or via an intermediate layer. When introducing the lining of the pipe, for example by applying a liquid PU material to the pipe by centrifuging, the insulator is then covered by the lining such that the inner diameter of the pipe is uniform all over.

The insulator is preferably tubular, i.e. in particular of hollow-cylindrical design such that, on the one hand, the introduction and fastening of the insulator in the pipe interior is possible in a simple manner, but at the same time a sufficiently large region of the interior lining is protected from the energy resulting during the welding of the pipe to the sleeve.

The insulator advantageously has a metal ring and, in particular, a further heat-insulating layer which is connected to the metal ring.

In particular in the case of pipe arrangements in which the sleeve or the pipe connector is not yet connected to one pipe prior to the lining thereof, both pipes each have, spaced from their end sides, an insulator between lining and metal wall. In this case, during the installation in situ, the sleeve can be pushed onto the pipe up to the height of the insulator and then welded to the pipe. Subsequently, the further pipe is then inserted into the sleeve and welded. In order to identify the insulator, it is advantageous to provide markings on the outer side of the pipe, which markings represent the centre and in particular also, as viewed in the longitudinal direction of the pipes, the front and rear edge of the insulator.

Advantageously, a pipe arrangement according to the invention has a sleeve which is of hollow-cylindrical design and whose inner wall extends, as viewed in the pipe longitudinal direction, at least substantially parallel to an outer side of the pipes. Preferably, this inner wall is completely parallel such that the pipes are automatically aligned by pushing the sleeve onto one pipe or inserting the further pipe. At the same time, the outside diameter of this pipe arrangement is less than in the prior art, since no thermal insulation or no insulator has to be arranged between sleeve and pipes.

For a pipe arrangement provided with a small outside diameter, it is also advantageous if the weld seam connects an end side of the sleeve to the pipe outer side, i.e., as viewed in a longitudinal section, the weld seam has an approximately lug-shaped or triangular design.

To provide a leaktight junction, it is particularly advantageous if the end sides of the pipes are provided with an abutting edge of plastic and the pipes in particular butt against one another. The connection here is brought together with a defined force and welded. The compression of the abutting edges when inserting the pipes in one another results in a sealing which protects the metal wall from the material to be transported. For introducing a defined force arrangement, the same markings which describe the position of the insulator can be provided. The pipe is then inserted into the sleeve until a corresponding marking and an end side of the sleeve lie above one another.

A pipe arrangement according to the invention can be produced more easily if the abutting edge of each pipe is formed in one piece with its lining.

A process according to the invention for producing a pipe arrangement as described above or described still further below is therefore distinguished in that the insulator is mounted on the inner side of the metal wall of at least one pipe at a spacing from its end side, then, by introducing the lining of the pipe, it is integrated into the latter, this pipe is then inserted into a sleeve mounted on a further pipe provided with a lining, and the sleeve is welded to the pipe along the insulator on the outer side of the pipe to its metal wall.

Further advantages and details of the invention can be taken from the following description of the figures. In the illustrations of the figures:

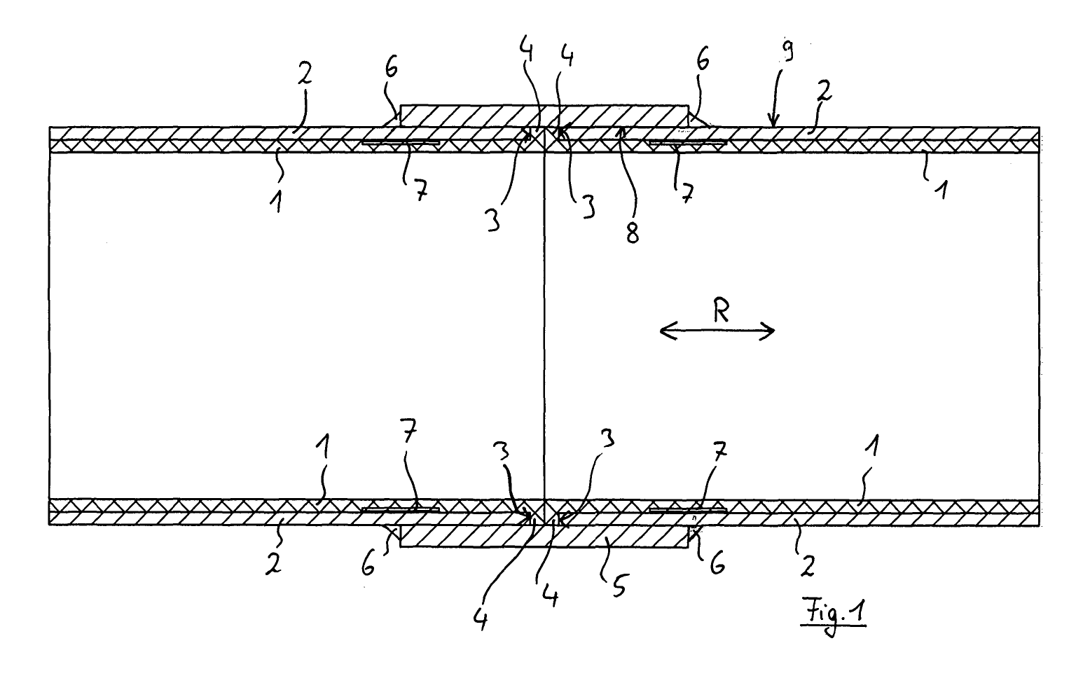

FIG. 1 schematically shows a longitudinal section through a pipe arrangement according to the invention,

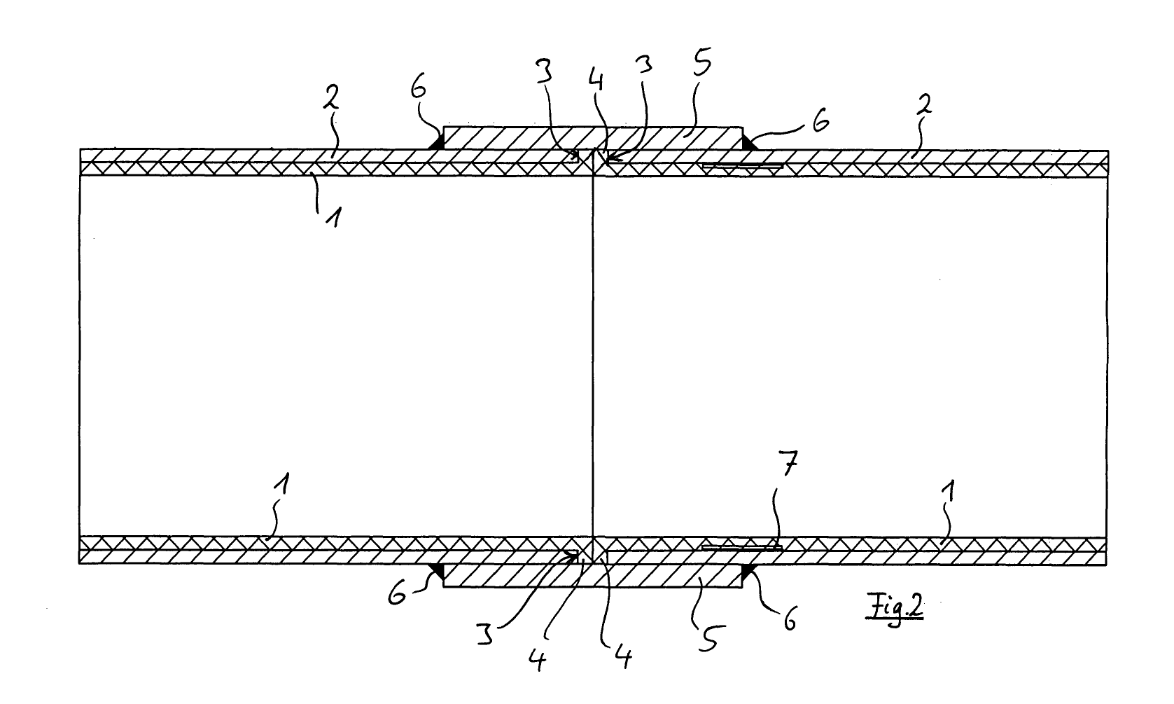

FIG. 2 schematically shows a further subject matter according to the invention in a view as per FIG. 1.

Parts which have an identical or similar effect are—where appropriate—provided with identical reference numbers. Individual technical features of the exemplary embodiments described below can also result, when combined with the features of the above-described exemplary embodiments, in developments according to the invention.

Pipes having an inner lining are in particular pipes for pipelines which transport highly abrasive materials, such as, for example, oil sands. The pipes according to FIG. 1 are in this respect provided with an internal lining 1 which is preferably produced from polyurethane or comprises polyurethane. On the outer side are situated the actual metal walls 2 of the pipe. For example, these are steel walls. The end sides 3 of the metal walls 2 are covered by an abutting edge 4 which is likewise produced from PU and connected in one piece to the inner lining 1.

The two abutting edges 4 of the linings 1 of the two pipes butt tightly against one another and form a seal. Before the two pipes are butted together, a sleeve 5 is mounted on one of the pipes and welded thereto. The first weld seam 6 is applied in a region in which an insulator or a thermal insulation is provided in the polyurethane material of the lining. By virtue of the insulator spaced apart from the end side and of the spaced-apart weld seam, there occurs neither any damage to the lining nor any effect on the abutting edges. In particular, the spacing of the insulator 7 from the end side 3 corresponds approximately to the length of the insulator itself (as viewed in the longitudinal direction R of the pipes).

In order to accelerate the connection of the pipes in situ, one pipe can typically already be provided on one side with a sleeve into which the further pipe can then be pushed in situ. In this case, the sleeve is already mounted on the metal wall at the factory before applying the PU layer, with the result that one of the insulators can be dispensed with (cf. FIG. 2). Outer sides 9 of the pipes and the inner side 8 of the sleeve extend parallel to one another, and the pipe or the sleeve is aligned by inserting a pipe into the sleeve.

The sleeve is connected to the metal walls in particular by means of fillet seam welding, with both automatic welding and manual welding being possible. A slight cavity which may be present between sleeve and metal walls of the two pipes is preferably not higher than 5 mm and can be filled, if appropriate, before welding the sleeve.

What is claimed is:

1.-15. (canceled)

16. A pipe arrangement comprising:
two pipes;
a sleeve;
the two pipes each having an outer metal wall and a heat-sensitive inner lining of plastic and an end side, wherein the end sides are facing one another;
the two pipes connected to one another by the sleeve arranged outside of the two pipes on the outer metal walls and welded at least to a first one of the two pipes by a first weld seam connecting the sleeve to the first pipe, wherein the first weld seam is spaced from the end side of the first pipe in a pipe longitudinal direction of the first pipe;
a first insulator integrated in a circumferential direction of the first pipe between the outer metal wall and the inner lining along the first weld seam.

17. The pipe arrangement according to claim 16, wherein the first insulator is already fastened to the outer metal wall of the first pipe during or before introduction of the inner lining of the first pipe.

18. The pipe arrangement according to claim 1 wherein the first insulator has a hollow-cylindrical basic shape.

19. The pipe arrangement according to claim 18, wherein the first insulator comprises a metal ring.

20. The pipe arrangement according to claim 1 wherein the first insulator further comprises a heat-insulating layer connected to the metal ring.

21. The pipe arrangement according to claim 16, wherein the first insulator is welded to the outer metal wall.

22. The pipe arrangement according to claim 16, further comprising a second insulator integrated in a circumferential direction of a second one of the two pipes between the outer metal wall of the second pipe and the inner lining of the second pipe along a second weld seam connecting the sleeve to the second pipe and spaced from the end side of the second pipe in a pipe longitudinal direction of the second pipe.

23. The pipe arrangement according to claim 16, wherein an inner side of the hollow-cylindrical sleeve extends at least substantially parallel to an outer side of the two pipes in the pipe longitudinal direction.

24. The pipe arrangement according to claim 23, wherein the first weld seam connects an end side of the sleeve to the outer side of the first pipe.

25. The pipe arrangement according to claim 16, wherein the end faces of the two pipes are provided with an abutting edge of plastic.

26. The pipe arrangement according to claim 25, wherein the end sides of the two pipes butt against one another.

27. The pipe arrangement according to claim 25, wherein the abutting edge of plastic is formed as one piece with the inner lining.

28. A process for producing a pipe arrangement according to claim 16, the method comprising:
mounting the first insulator on an inner side of the outer metal wall of the first pipe at a spacing from the end side of the first pipe;
introducing the inner lining into the first pipe so as to integrate the first insulator into the first pipe;
providing the second pipe with the inner fining and with the sleeve;
inserting the first pipe into the sleeve;
welding the sleeve to the outer side of the outer metal wall of the first pipe along the first insulator.

28. The process according to claim 27, connecting the sleeve to the second pipe prior to providing the inner lining on the second pipe.

29. The process according to claim 28, wherein the sleeve is welded to the second pipe.

30. The process according to claim 27, introducing a second insulator into the second pipe prior to providing the sleeve on the second pipe.

31. The process according to claim 27, wherein the sleeve is hollow-cylindrical and wherein one of the first and second pipes is aligned along an inner side of the sleeve by being inserted into the sleeve.
